(19) United States
(12) Patent Application Publication
(10) Pub. No.: US 2018/0075497 A1
(43) Pub. Date: Mar. 15, 2018

(54) DATABASE MANAGEMENT SYSTEM

(71) Applicant: Amadeus S.A.S., Biot (FR)

(72) Inventors: Pierre Beguerie, Le Cannet (FR); Araceli Paula Catalano, Buenos Aires (AR); María Guadalupe García Pizales, Buenos Aires (AR); Sébastien Bardin, Vaucresson (FR); Alexandre Chabod, Peymeinade (FR); Axel Pierre Frédéric Simpson-Lando, Hounslow (GB); Amal Hjije, Antibes (FR)

(21) Appl. No.: 15/260,617

(22) Filed: Sep. 9, 2016

(51) Int. Cl. G06Q 30/02; G06F 17/30; G06Q 10/02; G06Q 30/04

(52) U.S. Cl. CPC G06Q 30/0283; G06F 17/30477; G06Q 30/04; G06Q 10/02; G06F 17/30554

(57) ABSTRACT

Systems, methods, and computer program products for creating and managing database records. A database management system receives requests to exchange tickets. In response to determining that a request requires enhanced processing, the system queries a penalty collection database for instructions on providing the enhanced processing. The instructions may be identified based on an identity of a provider of a travel product and/or the market in which the product is sold. The penalty collection database may include a table that provides instructions on collecting the penalty which are indexed to a specific provider, market, or combination of provider and market. If a penalty is owed for the exchange, the instructions may cause the system to implement a specific method of collecting the penalty. The instructions may cause the penalty to be encoded and stored in a manner specific to the provider and/or market to avoid an incompatibility with another system.

### BACKGROUND

The invention generally relates to computers and computer systems and, in particular, to systems, methods, and computer program products for creating and managing database records that support specific tasks.

In the information age, user systems must typically interact with multiple different computer systems when performing tasks. For example, in the travel industry, travel agency systems may be required to interact with reservation systems operated by different travel providers in order to book travel products for customers. When a travel product is reserved, one or more electronic records documenting the reserved travel product may be stored in a database record in a database operated by the travel provider. Each provider database may comprise a collection of records that contain information about travelers and their itineraries, and may operate under rules specific to that provider regarding how the database records and messaging between systems must be formatted.

In particular, process of issuing and managing tickets may result in generation of one or more database records that document the purchase of a travel product such a seat on a flight. Database records that may be created and/or modified in response to the issuance of a ticket may include, for example, electronic tickets, passenger name records (PNRs), and Electronic Miscellaneous Documents (EMDs). In some instances, a traveler's plans may change after a ticket has been issued, in which case the traveler may wish to exchange the ticket. Modifying, exchanging, or canceling a ticket after an initial booking by a traveler often triggers a penalty that must be paid to the provider. However, the rules for formatting and transmitting records to document penalties typically vary between providers and markets, and are often incompatible with processing and database systems of third party service providers, such as fare calculation systems provided by the Airline Tariff Publishing Company (ATPCO), billing service provider systems, and/or clearing house systems. The process of managing records may be compounded by scenarios in which a single traveler has used more than one travel agency and/or provider to book their trip, resulting in multiple different database records being affected by a request to modify or exchange a ticket.

Thus, improved systems, methods, and computer program products for processing and exchanging data with databases managed by different service provider systems are needed.

### SUMMARY

In an embodiment of the invention, a database management system for processing an exchange of an issued ticket for a reissue ticket is provided. The system includes one or more processors and a memory coupled to the processors. The memory stores first data comprising a first database and instructions that, when executed by the one or more processors, causes the system to receive a request to reprice a reservation record from a user system. The database management system determines a context of the exchange, and queries the first database for a penalty collection process that matches the context of the exchange. The system further determines a penalty for exchanging the issued ticket for the reissue ticket in accordance with the penalty collection process returned by the first database, and generates a price for the reissue ticket based at least in part on the penalty. The system then transmits a reply to the user system that includes the price for the reissue ticket.

In another aspect of the invention, the instructions may further cause the database management system to attach a dedicated message to the reply that identifies the penalty collection process.

In another aspect of the invention, the instructions may further cause the database management system to display, on the user system based on the dedicated message attached to the reply, data indicative of the penalty collection process.

In another aspect of the invention, the data indicative of the penalty collection process may indicate whether the penalty is included in the reissue ticket, the penalty is included in the reissue ticket and the reservation record needs an update, or the penalty is not included in the reissue ticket.

In another aspect of the invention, the instructions may further cause the database management system to create a persistent element in the reservation record, and store at least a portion of the dedicated message in the persistent element.

In another aspect of the invention, the penalty collection process may define how the penalty is added to a transitional ticket corresponding to an itinerary defined by the reservation record, and the instructions may further cause the system to generate the transitional ticket, add a tax element or a surcharge element to the transitional ticket, and store the penalty in the tax element or the surcharge element.

In another aspect of the invention, the instructions may further cause the database management system to add the penalty to a total amount for the transitional ticket, and store the total amount in a total amount element of the transitional ticket.

In another aspect of the invention, the context of the exchange may include data defining an element selected from the group consisting of a market in which the reissue ticket is being sold, and a validating carrier for a segment of the reissue ticket

In another aspect of the invention, the request may include a record locator that identifies the reservation record, and the instructions may cause the system to determine the context of the exchange by retrieving the reservation record identified by the record locator from a second database of reservation records, and identifying, based on the reservation record, the validating carrier and/or the market in which the reissue ticket was sold.

In another aspect of the invention, if the penalty is not included in the reissue ticket, the data indicative of the penalty collection process may further indicate how to account for the penalty.

In another embodiment of the invention, a method of processing the exchange of the issued ticket for the reissue ticket is provided. The method may include receiving, from the user system, the request to reprice a reservation record. The method may further include determining the context of the exchange, and querying the first database for the penalty collection process that matches the context of the exchange. The method may further include determining the penalty for exchanging the issued ticket for the reissue ticket in accordance with the penalty collection process returned by the first database, and generating the price for the reissue ticket based at least in part on the penalty. The method may then transmit the reply that includes the price for the reissue ticket to the user system.

In another embodiment of the invention, a computer program product is provided. The computer program product may include a non-transitory computer-readable storage medium, and program code stored on the medium. When executed by one or more processors, the program code may cause the processors to receive the request to reprice the reservation record from the user system. The program code may further cause the processors to determine the context of the exchange, and query the first database for the penalty collection process that matches the context of the exchange. The program code may further cause the processors to determine the penalty for exchanging the issued ticket for the reissue ticket in accordance with the penalty collection process returned by the first database, and generate the price for the reissue ticket based at least in part on the penalty. The program code may then cause the processors to transmit the reply that includes the price for the reissue ticket to the user system.

The above summary may present a simplified overview of some embodiments of the invention in order to provide a basic understanding of certain aspects the invention discussed herein. The summary is not intended to provide an extensive overview of the invention, nor is it intended to identify any key or critical elements, or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention.

FIG. 1 is a diagrammatic view of an exemplary operating environment including a database management system in communication with a user system, a fares database, and a penalty collection database.

FIG. 2 is a diagrammatic view of an exemplary computer that may be used to provide the operating environment of FIG. 1.

FIG. 3 is a diagrammatic view of the database management system of FIG. 1 depicting a pricing gateway in communication with the user system of FIG. 1, a pricing engine in communication with the fares database of FIG. 1, and an enhanced pricing engine.

FIG. 4 is a diagrammatic view of the database management system of FIG. 3 further depicting the pricing engine in communication with the enhanced pricing engine, and the enhanced pricing engine in communication with the penalty collection database of FIG. 1.

FIG. 5 is a diagrammatic view of a penalty collection table that may be provided by the penalty collection database of FIGS. 3 and 4.

### DETAILED DESCRIPTION

Embodiments of the invention may be implemented by a data processing system that provides processing and database functions which enable and/or facilitate interconnections and data processing between one or more database systems. Embodiments of the invention include a database management system that provides an interface between a user system and the database systems. The database management system may receive queries from the user system, parse the received queries, and generate new queries for transmission to selected database system based on the parsed data. The database management system may then generate replies to the queries received from the user system based on the replies received from the databases.

In the context of air travel, the queries received from the user systems may include a query that requests repricing of an issued ticket that is being exchanged by a traveler. In the event that a penalty is owed for the exchange, the database management system may query a penalty collection database for instructions on how to collect the penalty. The penalty collection database may include one or more tables that provide penalty collection processes which are indexed to a context of the exchange. The instructions retrieved from the table may cause the database management system to encode and store the penalty in a specific database record, such as a database record corresponding to the reissue ticket, and in a manner specific to the context of the exchange.

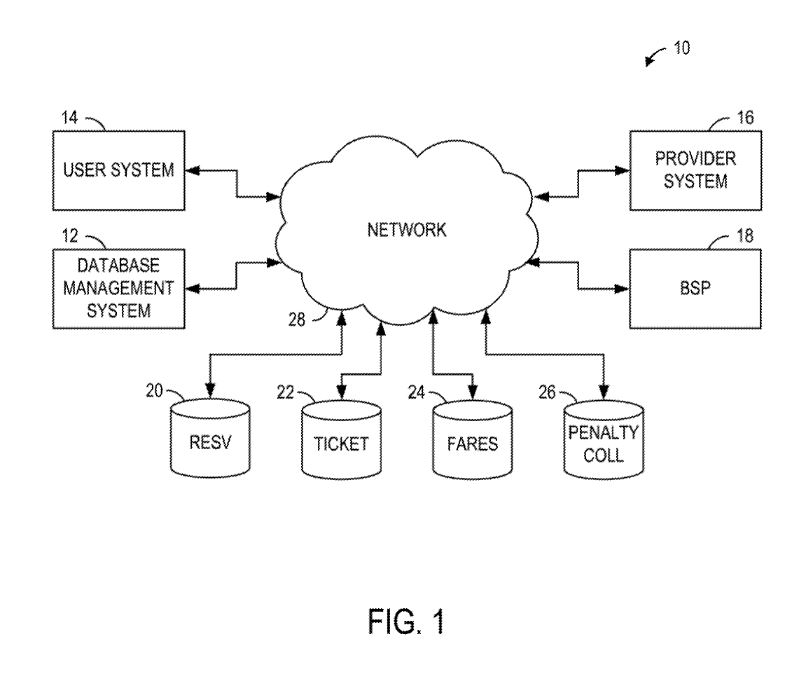

Referring now to FIG. 1, an operating environment 10 in accordance with an embodiment of the invention may include a database management system 12, a user system 14, a provider system 16, a Billing and Settlement Plan (BSP) system 18, a reservation database 20, a ticket database 22, a fares database 24, and a penalty collection database 26. Each of the database management system 12, user system 14, provider system 16, BSP system 18, reservation database 20, ticket database 22, fares database 24, and penalty collection database 26 may communicate through a network 28. The network 28 may include one or more private or public data networks (e.g., the Internet) that enable the exchange of data between systems connected to the network 28.

The database management system 12 may be configured to receive and process queries from the user system 14. The user system 14 may be a travel agency system, airline reservation system, travel web site system, or any other system used to search for, reserve, purchase, and/or exchange travel products. The queries received by the database management system 12 may include, for example, search queries, informative pricing queries, confirmed pricing queries, ticket issue requests, ticket reissue requests, or any other query associated with searching for, pricing, booking, and ticketing of travel products.

Queries may include data defining an origin, a destination, a number of spaces to be reserved, a period of time during which travel is desired, a specific flight, or any other information relevant to the purpose of the query. In response to receiving a query, the database management system 12 may communicate with one or more of the user system 14, provider system 16, BSP system 18, reservation database 20, ticket database 22, fares database 24, penalty collection database 26, or any other suitable system to process the query.

The provider system 16 may include a Computer Reservation System (CRS) that enables the database management system 12 to reserve and pay for travel products, such as airline tickets. For providers of air travel, the CRS may manage reservations for spaces between nodes of a travel network. Each node of the travel network may comprise a station (e.g., an airport) to and from which the provider operates flights. The provider system 16 may also interact with other provider systems, either directly or through the database management system 12, to enable a validating carrier to sell tickets for spaces provided by the operating carrier. The operating carrier may then bill the validating carrier for the products provided.

The BSP system 18 may be configured to receive data from a ticketing office of the travel agency or validating carrier reporting the sale of the ticket in the name of the operating carrier. In the United States, the Airline Reporting Corporation (ARC) may provide this service. The BSP may act as a Business Process Outsourcer (BPO) that provides a clearing house which settles accounts between travel agencies and validating carriers. Other systems (not shown) may also be connected to the network 28 for settling accounts between operating and validating carriers, such as systems operated by the IATA Clearing House (ICH) or Airlines Clearing House (ACH). When present, these various clearing house systems may facilitate collection of fares by the operating carrier for providing products sold by another business entity.

In response to the user system 14 transmitting a request to reserve a travel product, such as a flight, the database management system 12 may generate a new reservation record, or modify an existing reservation record, in the reservation database 20. The reservation record may include one or more fields or elements that contain data which defines itinerary and traveler information associated with one or more reserved travel products. The itinerary may include travel products from multiple travel product providers. To facilitate locating the reservation record in the reservation database 20, a record locator or other suitable identifier may be associated with the reservation record. In an embodiment of the invention, the reservation record may comprise a Passenger Name Record (PNR) stored in a PNR database.

The reservation record may include elements that identify segments on which space has been reserved. A space may be distinguished from a seat based on the concept of overbooking. Overbooking refers to the practice by which providers book more spaces than there are physical seats on a flight in anticipation that some booked spaces will go unused due to passengers failing to show up at the time of departure. A segment may refer to the operation of an aircraft between a point where passengers first board the aircraft and a point where the passengers exit the aircraft for a final time. A segment may include any number of stops where passengers can exit and re-board the same aircraft. A flight may refer to the operation of one or more segments with the same flight designator, and may involve more than one aircraft. To book a flight that includes multiple segments, multiple elements each defining a segment of the flight may be created in the reservation record.

Reserving a travel product may include checking the provider inventory for availability of the product, e.g., available space on the segments comprising the itinerary. This check may include sending a reservation request from the user system 14 to the database management system 12. The database management system 12 may in turn query a corresponding provider system 16 for availability of the products requested. If the requested products are available, the products may be reserved, and the provider inventory decreased to reflect the reservation.

The ticket database 22 may be managed by an electronic ticketing system configured to maintain records relating to the issuance, modification, and use of electronic tickets. Each ticket may comprise a database record that defines flight information such as a validating carrier, an operating carrier, a flight number, an origin for the flight, a destination for the flight, a booking class, and flight dates. Tickets may be issued by the electronic ticketing system in response to receiving an indication that an associated reservation record has been confirmed. The electronic ticketing system may populate elements in the ticket based on data stored in the reservation record. This information may include details for each segment defined in the reservation record, such as booking class, date of departure, boarding point, deplaning point, an identity of the passenger, one or more forms of payment used to purchase the segment, etc.

The ticket may include elements that define a “coupon”. Each ticket may include a corresponding coupon for each segment of the flight itinerary in the corresponding reservation record. Each coupon may identify a specific segment for which the ticket can be used to obtain a boarding pass. The status of a coupon may be “open” if the coupon is unused, “flown” if the coupon has been used, or “exchanged” if the coupon has been exchanged for another flight. The ticket may be stored in the ticket database 22. Each ticket in the ticket database 22 may have a unique identifier, or ticket number, which may be stored in an element of the ticket. To retrieve data stored in the ticket, an ticket display request may be transmitted to the ticket database 22. In response to receiving the display query, the ticket database 22 may return data from the database record matching the ticket number.

Tickets may include additional coupons that can be used to obtain other products. The ticket database 22 may also store other types of electronic documents, such as an EMD, that represent a payment for chargeable services which have been purchased by the traveler. These chargeable services may be represented in the reservation record using Special Service Requests (SSRs). Services that are chargeable may be associated to an EMD and coupon number in the reservation record.

In some cases, tickets and reservation records may be required to adhere to certain standard formats so that compatibility is maintained between various user and provider systems. Thus, it may not always be possible to add new data structures, or otherwise modify, ticket and reservation records in order to support new features in the database management system 12. To address this issue, the ticket database 22 may support a transitional ticket. A transitional ticket may be a database record configured to store non-standard data structures. Transitional tickets may be used by the database management system 12 to provide various features of embodiments of the present invention.

The fares database 24 may provide fare data in a standardized electronic format to facilitate processing of fares published by different carriers. The fares database 24 may be operated by a third party tariff publishing company, such as the Airline Tariff Publishing Company (ATPCO), that publishes airfares for multiple carriers. The fare data may define rules that are organized into categories. These categories may define a system of rules which identifies various kinds of restrictive information regarding each fare.

For example, category 31 may provide rules for automatic processing of voluntary ticket exchanges that ensures the correct additional collection or refund amount is calculated for the exchange. Category 31 may be used in combination with other applicable categories to determine any penalties that are owed. For example, category 16 may provide rules for determining if penalties are applicable for the fare and what charges need to be assessed. Other rule categories may define fare rules such as passenger eligibility requirements, day and time restrictions, advanced reservations/ticketing, minimum/maximum stay requirements, blackout dates, etc.

The penalty collection database 26 may store one or more penalty collection tables that define how penalties are to be processed based on a context of the exchange. For embodiments in which the context of the exchange defines a carrier and/or a market for the exchange, the penalty collection database 26 may provide a hierarchical matching process based on the carrier providing the segment and a market in which the segment is provided.

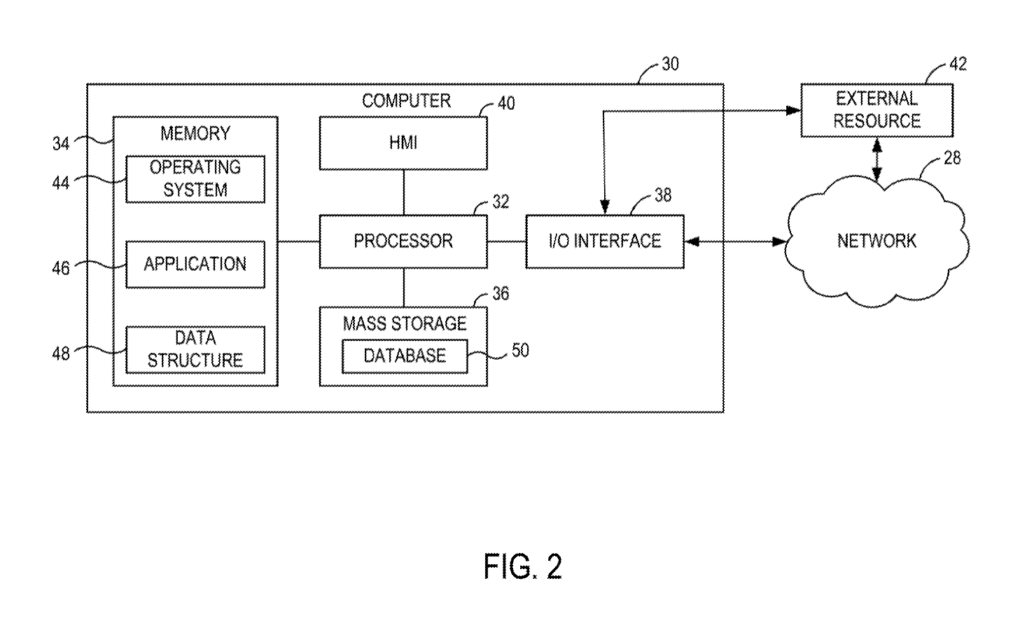

Referring now to FIG. 2, the database management system 12, user system 14, provider system 16, BSP system 18, reservation database 20, ticket database 22, fares database 24, and penalty collection database 26 of operating environment 10 may be implemented on one or more computer devices or systems, such as exemplary computer 30. The computer 30 may include a processor 32, a memory 34, a mass storage memory device 36, an input/output (I/O) interface 38, and a Human Machine Interface (HMI) 40. The computer 30 may also be operatively coupled to one or more external resources 42 via the network 28 or I/O interface 38. External resources may include, but are not limited to, servers, databases, mass storage devices, peripheral devices, cloud-based network services, or any other suitable computer resource that may be used by the computer 30.

The processor 32 may include one or more devices selected from microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions that are stored in memory 34. Memory 34 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or any other device capable of storing data. The mass storage memory device 36 may include data storage devices such as a hard drive, optical drive, tape drive, volatile or non-volatile solid state device, or any other device capable of storing data.

The processor 32 may operate under the control of an operating system 44 that resides in memory 34. The operating system 44 may manage computer resources so that computer program code embodied as one or more computer software applications, such as an application 46 residing in memory 34, may have instructions executed by the processor 32. The processor 32 may also execute the application 46 directly, in which case the operating system 44 may be omitted. The one or more computer software applications may include a running instance of an application comprising a server, which may accept requests from, and provide replies to, one or more corresponding client applications. One or more data structures 48 may also reside in memory 34, and may be used by the processor 32, operating system 44, and/or application 46 to store or manipulate data.

The I/O interface 38 may provide a machine interface that operatively couples the processor 32 to other devices and systems, such as the network 28 or external resource 42. The application 46 may thereby work cooperatively with the network 28 or external resource 42 by communicating via the I/O interface 38 to provide the various features, functions, applications, processes, or modules comprising embodiments of the invention. The application 46 may also have program code that is executed by one or more external resources 42, or otherwise rely on functions or signals provided by other system or network components external to the computer 30. Indeed, given the nearly endless hardware and software configurations possible, it should be understood that embodiments of the invention may include applications that are located externally to the computer 30, distributed among multiple computers or other external resources 42, or provided by computing resources (hardware and software) that are provided as a service over the network 28, such as a cloud computing service.

The HMI 40 may be operatively coupled to the processor 32 of computer 30 to enable a user to interact directly with the computer 30. The HMI 40 may include video or alphanumeric displays, a touch screen, a speaker, and any other suitable audio and visual indicators capable of providing data to the user. The HMI 40 may also include input devices and controls such as an alphanumeric keyboard, a pointing device, keypads, pushbuttons, control knobs, microphones, etc., capable of accepting commands or input from the user and transmitting the entered input to the processor 32.

A database 50 may reside on the mass storage memory device 36, and may be used to collect and organize data used by the various systems and modules described herein. The database 50 may include data and supporting data structures that store and organize the data. In particular, the database 50 may be arranged with any database organization or structure including, but not limited to, a relational database, a hierarchical database, a network database, an object-oriented database, or combinations thereof

A database management system in the form of a computer software application executing as instructions on the processor 32 may be used to access data stored in records of the database 50 in response to a query, where the query may be dynamically determined and executed by the operating system 44, other applications 46, or one or more modules. Although embodiments of the invention may be described herein using relational, hierarchical, network, object-oriented, or other database terminology in specific instances, it should be understood that embodiments of the invention may use any suitable database management model, and are not limited to any particular type of database.

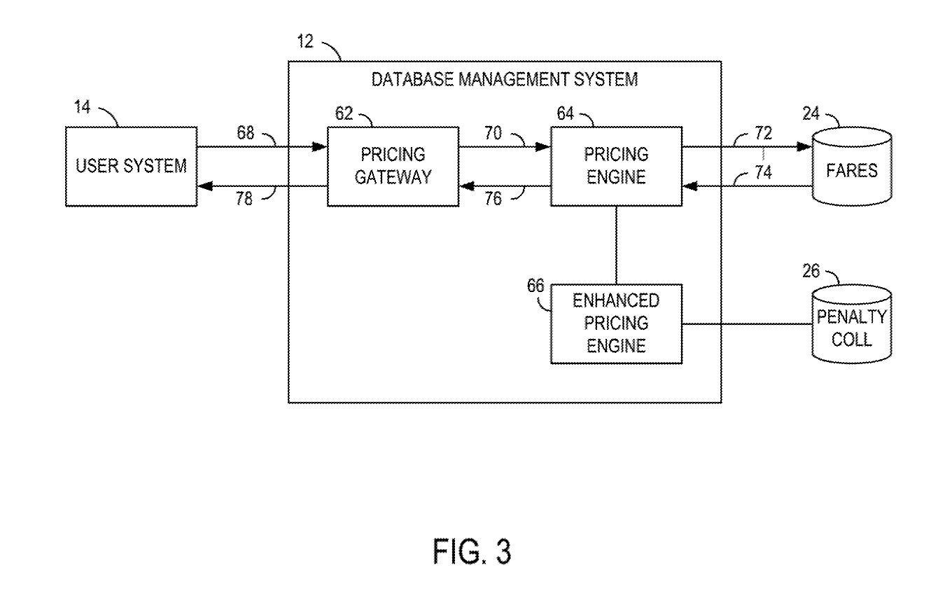

Referring now to FIG. 3, the database management system 12 may include a pricing gateway 62 configured to receive requests from the user system 14, a pricing engine 64 configured to communicate with the fares database 24 and price itineraries, and an enhanced pricing engine 66 configured to communicate with the penalty collection database 26, obtain instructions on processing penalties associated with the exchange of a ticket, and provide enhanced data to the pricing engine 64.

To price an itinerary, the user system 14 may transmit a pricing request 68 to the pricing gateway 62. The pricing request 68 may identify a reservation record defining an itinerary to be priced, e.g., by providing a record locator to the pricing gateway 62. In response to receiving the pricing request 68, the pricing gateway 62 may retrieve the reservation record identified by the pricing request 68, and transmit a pricing computation request 70 to the pricing engine 64. The pricing computation request 70 may include data identifying the ticketing office, origin, destination, type of fare, and/or any other data needed to price a ticket for the itinerary defined by the reservation record. In an alternative embodiment, the pricing computation request 70 may include the reservation record identifier, and the pricing engine 64 may retrieve the data needed to price the ticket directly from the reservation record.

In response to receiving the pricing computation request 70, the pricing engine 64 may transmit a fare query 72 to the fares database 24 requesting fare data for the itinerary. In response to receiving the fare query 72, the fares database 24 may transmit a fare reply 74 to the pricing engine 64 that includes data defining fares, tariffs, and/or fare restrictions for the itinerary.

The pricing engine 64 may analyze the restrictions received from the fares database 24 to determine if the fare can be applied to the itinerary. If the itinerary being priced satisfies the fare restrictions, the pricing engine 64 may further determine any additional charges, such taxes, fees, surcharges, etc., related to the itinerary. These additional charges may include local taxes based on the departure, connecting, and destination locations, passenger facility charges, airport fees, etc. The pricing engine 64 may then determine a total price for ticketing the itinerary by summing the fares and additional charges, and transmit a pricing computation reply 76 to the pricing gateway 62. A final priced itinerary may then be ready for booking and issuance of the ticket.

Once the itinerary has been priced, the pricing gateway 62 may transmit a pricing reply 78 to the user system 14 requesting confirmation of the transaction. In response to receiving a confirmation (not shown) from the user system 14, the database management system 12 may commit to the reservation record, transmit a request to the ticket database 22 to generate tickets for the itinerary, and cause the traveler's account to be billed for the amount determined by the pricing engine 64.

In some cases, a traveler may wish to make a change in their itinerary after the ticket has been issued. Voluntary changes to a ticketed itinerary may be handled by a full exchange of the ticket, or by a partial exchange of the ticket. In the case of a partial exchange, there may be two co-existing tickets in the ticket database 22 that each provide a part of the traveler's total itinerary. In either case, to make the exchange, a new itinerary may be defined in the reservation record in accordance with the changes requested by the traveler. A reissue ticket may then be generated based on the updated reservation record.

When a ticket is exchanged or modified, it may be necessary to reprice the ticket by determining a residual value of the old ticket and a price of the new ticket. If the new ticket has a higher price than the residual value of the old ticket, an additional payment may be collected from the traveler. If the residual value of the old ticket is higher than the price of the new ticket, a refund may be credited to the traveler. If any penalties are due for the exchange, these may be accounted for by subtracting the cost of the penalties from the refund, or adding the cost of the penalties to the additional payment. One way penalties may be handled by the database management system 12 is by generating a record in the ticket database 22 for this purpose, such as a Miscellaneous Change Order (MCO). This record may include an element for storing data defining any penalties, and how the penalties are to be collected.

In some cases, the BSP system 18 may be unable to process records other than standard tickets. This may prevent the database management system 12 from using other types of records to manage penalties. In markets where the BSP system 18 does not allow the use of MCO's, carriers may each define a process to account for any penalties in the ticket record that avoids the use of database records other than tickets. For example, penalties may be added to elements in the fare calculation line of the ticket that are normally reserved for other types of charges, e.g., taxes, surcharges, or total charges. The costs of penalties may also be collected directly through a specific link provided by the BSP system 18. Each carrier may have a procedure for adding penalties, and the procedures may vary between carriers and/or markets.

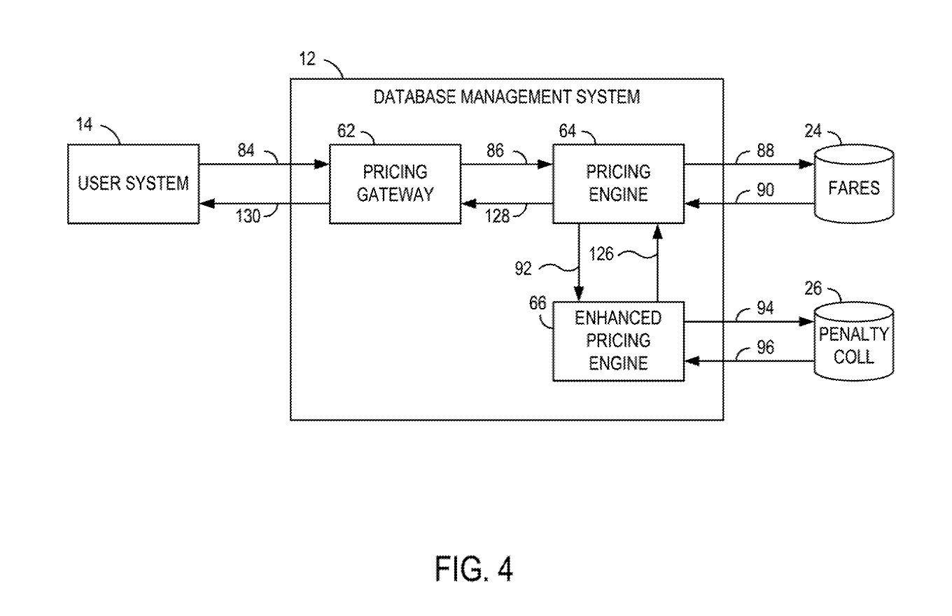

Referring now to FIG. 4, to reprice an itinerary that has been previously ticketed, the user system 14 may transmit a repricing request 84 to the pricing gateway 62. The repricing request 84 may identify the reservation record defining the new itinerary and the ticket being exchanged/repriced. In response to receiving the repricing request 84, the pricing gateway 62 may retrieve the reservation record identified the repricing request 84, and/or transmit a repricing computation request 86 to the pricing engine 64. The repricing computation request 86 may include data identifying the ticketing office, origin, destination, type of fare, the ticket being exchanged, the carrier, the market in which the ticket being exchanged was sold, a flag indicating whether enhanced repricing is requested, and/or any other data needed to reprice the ticket.

In response to receiving the repricing computation request 86, the pricing engine 64 may transmit a fare query 88 to the fares database 24. The fare query 88 may request the fares and restrictions for the itinerary identified by the repricing computation request 86 and/or the itinerary defined by the ticket being exchanged. In response to receiving the fare query 88, the fares database 24 may transmit a reply 90 to the pricing engine 64 that includes data defining the fares and restrictions for the itinerary being repriced and/or the original ticketed itinerary.

If enhanced pricing is indicated, the pricing engine 64 may transmit an enhanced repricing request 92 to the enhanced pricing engine 66. Enhanced repricing may be indicated, for example, if the ticketing office and/or market in which the ticket is being exchanged is one in which the BSP system 18 does not process separate penalty records. In response to receiving the enhanced repricing request 92, the enhanced pricing engine 66 may determine a context of the exchange, and transmit a query 94 defining the context to the penalty collection database 26.

The context of the exchange may include, for example, the identity of the carrier providing the travel product being exchanged, and/or a market in which the travel product is being used, sold, or exchanged. The market may be defined, for example, by the origin and destination of the original itinerary or the modified itinerary, and/or by the location of the ticketing office. In response to receiving the query 94, the penalty collection database 26 may transmit a reply 96 to the enhanced pricing engine 66 that includes data defining instructions for handling an exchange penalty.

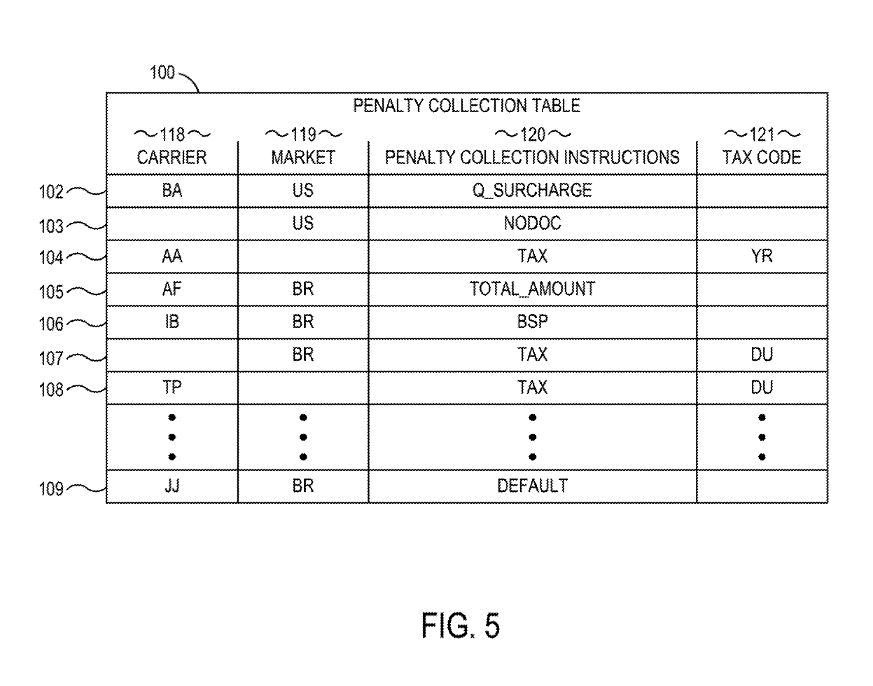

Referring now to FIG. 5, the penalty collection database 26 may include data structures that define carriers, markets, and instructions for handing a penalty for exchanging a ticket, as well as associations between the carriers, markets, and instructions. In an exemplary embodiment of the penalty collection database 26, this information may be provided by a penalty collection table 100. The penalty collection table 100 may include a plurality of rows (e.g., rows 102-109) and a plurality of columns (e.g., columns 118-121). Each intersection of a row and a column may define a cell, with each cell containing data associated with the row and the column that defines the cell. Each cell may be further associated with a pointer that points to a memory location where the data in the cell is stored.

Each cell defined by column 118 may store data that identifies a carrier. This data may, for example, include the two letter International Air Transport Association (IATA) airline code. Each cell defined by column 119 may store data that identifies a market, e.g., by including the IATA two letter country code, IATA airport code, or any other suitable data. Column 120 may define cells that store instructions which define a penalty collection process, and column 121 may define cells that store data which identifies a tax code that should be used in cases where penalties are encoded as a tax in the ticket.

By way of example, the penalty collection process defined in column 120 may indicate that the penalty should be added to the ticket as a Q-Surcharge in the fare calculation line of the ticket (e.g., “Q SURCHARGE”), added to the ticket as a tax in the fare calculation line of the ticket (e.g., “TAX”), added to the total amount element of the fare calculation line of the ticket (e.g., “TOTAL_AMOUNT”), transmitted through a specific link provided by the BSP system 18 (e.g., “BSP”), billed and/or added to the ticket using a default method, or handled in some other suitable way. If the instructions defining the penalty collection process indicate a tax is to be added to the fare calculation line of the ticket, the tax code used may be defined in a corresponding cell defined by the associated cell in column 121. In some instances, the instructions may indicate that the penalties are not to be automatically accounted for by the database management system 12 (e.g., “NODOC”). In this case, the penalties may be collected outside the database management system 12, or not collected at all.

The penalty collection database 26 may define a specific penalty collection process for each carrier, market, and/or carrier-market combination. The enhanced pricing engine 66 may use a hierarchical matching process to identify the penalty collection process that should be used. The hierarchical matching process may determine how the penalty is managed based on the context of the exchange. For example, in an embodiment of the invention, the enhanced pricing engine 66 may first attempt to retrieve instructions from a row that matches both the carrier and the market identified in the repricing request. If a row matching both the carrier and the market is not present, the enhanced pricing engine 66 may next attempt to retrieve instructions from a row that matches the carrier. If a row matching the carrier is also not present, the enhanced pricing engine 66 may next attempt to retrieve instructions that match the market.

How the amounts used to populate the fare calculation line of the ticket are determined by the enhanced pricing engine 66 may vary depending on the penalty collection process returned by the penalty collection database 26. For example, if the instructions indicate the penalty is to be added to a tax element of the ticket, the enhanced pricing engine 66 may determine that the penalty should be added to the reissue ticket as a tax, but that the tax should be treated as a penalty. If the instructions indicate the penalty is to be added as a surcharge element, a surcharge (e.g., a Q Surcharge) may be added to the fare calculation line of the reissue ticket.

The use of enhanced pricing may impact one or more automatic ticketing features. For example, the reissue penalty may be considered as non-refundable in a subsequent exchange. This may be in contrast to actual taxes, which may be refunded for portions of the ticket that have not been used. To address this issue, the enhanced pricing engine 66 may set a flag in the reservation record, reissue ticket, or some other location indicating that revalidation cannot be offered for tickets issued with a penalty in the ticket. Indeed, the presence of a penalty in the ticket may imply that a new ticket was created, i.e., that the current ticket was reissued rather than revalidated. The netting process may also be enhanced to consider the penalty amount as a penalty regardless of the collection method (e.g., tax, surcharge, or total amount).

Referring again to FIG. 4, the enhanced pricing engine 66 may transmit an enhanced pricing reply 126 to the pricing engine 64. The enhanced pricing reply 126 may include data used to determine and implement the penalty collection process. This data may be combined with the data defining the fares and restrictions for the requested fares in reply 90, and the combined data transmitted to the pricing gateway 62 in a repricing computation reply 128.

The data in the repricing computation reply 128 may be used by the pricing gateway 62, for example, to generate structured amounts that are transmitted to the electronic ticketing system for traceability. The data in the repricing computation reply 128 may also be used by the pricing gateway 62 to generate a dedicated message. The dedicated message may be appended to a repricing reply 130 that is transmitted to the user system 14. The dedicated message may be displayed by the user system 14, and may contain, for example, information regarding how the penalty was added to the ticket. The dedicated message may also include dedicated indicators for generating documents, and for reporting and collecting statistics. In cases where the penalty could not be added to the ticket, the dedicated message may include instructions to the agent informing them of additional tasks that need to be performed to collect the penalty.

The pricing gateway 62 may implement the penalty collection process based on the data in the repricing computation reply 128. Implementation may include creating and/or modifying the reservation record and/or the ticket in conformance with the instructions. To this end, the penalty amounts indicated in the repricing computation reply 128 may be added to elements in the fare calculation line of the ticket, or otherwise processed in accordance with the instructions.

The pricing gateway 62 may also append the relevant dedicated messages to the repricing reply 130 transmitted to the user system. Information displayed by the user system 14 in response to receiving the repricing reply 130 and appended dedicated messages may inform the user that a specified penalty collection process has been applied to collect the penalty. The displayed information may include specific warnings added by the pricing gateway 62 depending on the use case. The penalty amount may also be displayed independently from the information describing the penalty collection process.

In an embodiment of the invention, and in response to receiving a repricing confirmation from the user system 14, the database management system 12 may cause a new ticket to be issued. The process of issuing the ticket may include generating input for the pricing engine 64. This input may include relevant data for penalty collection computation, such as an ARP value of the travel agent, office data, and carrier data.

The pricing engine 64 may compute the penalty collection process needed depending on the data retrieved from the penalty collection database 26. The database management system 12 may process the output of the pricing engine 64, and translate the penalty collection process returned by the pricing engine 64 into a series of steps that create database records which support penalty collection. The database management system 12 may also decode penalty amounts and generate dedicated messages to appended to responses for display by the user system 14. The database management system 12 may also generate pricing records depending on the penalty collection process used to collect the penalty. To this end, the database management system 12 may query the fares database 24, and format the output depending on the penalty collection process.

The reissue ticket may be generated with the penalty included in the ticket depending on the penalty collection process. A persistent element may be created in the reservation record that stores the output generated by the database management system 12 so that the output can be retrieved at a later time. The output may indicate that the penalty was collected as a tax in the ticket, added to the total amount of the ticket, added as a surcharge in the fare calculation, or not collected at all, in which case the agent may be responsible for collecting the penalty.

In general, the routines executed to implement the embodiments of the invention, whether implemented as part of an operating system or a specific application, component, program, object, module or sequence of instructions, or a subset thereof, may be referred to herein as “computer program code,” or simply “program code.” Program code typically comprises computer-readable instructions that are resident at various times in various memory and storage devices in a computer and that, when read and executed by one or more processors in a computer, cause that computer to perform the operations necessary to execute operations and/or elements embodying the various aspects of the embodiments of the invention. Computer-readable program instructions for carrying out operations of the embodiments of the invention may be, for example, assembly language or either source code or object code written in any combination of one or more programming languages.

Various program code described herein may be identified based upon the application within which it is implemented in specific embodiments of the invention. However, it should be appreciated that any particular program nomenclature which follows is used merely for convenience, and thus the invention should not be limited to use solely in any specific application identified and/or implied by such nomenclature. Furthermore, given the generally endless number of manners in which computer programs may be organized into routines, procedures, methods, modules, objects, and the like, as well as the various manners in which program functionality may be allocated among various software layers that are resident within a typical computer (e.g., operating systems, libraries, API's, applications, applets, web based services, etc.), it should be appreciated that the embodiments of the invention are not limited to the specific organization and allocation of program functionality described herein.

The program code embodied in any of the applications/modules described herein is capable of being individually or collectively distributed as a program product in a variety of different forms. In particular, the program code may be distributed using a computer-readable storage medium having computer-readable program instructions thereon for causing a processor to carry out aspects of the embodiments of the invention.

Computer-readable storage media, which is inherently non-transitory, may include volatile and non-volatile, and removable and non-removable tangible media implemented in any method or technology for storage of information, such as computer-readable instructions, data structures, program modules, or other data. Computer-readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. A computer-readable storage medium should not be construed as transitory signals per se (e.g., radio waves or other propagating electromagnetic waves, electromagnetic waves propagating through a transmission media such as a waveguide, or electrical signals transmitted through a wire). Computer-readable program instructions may be downloaded to a computer, another type of programmable data processing apparatus, or another device from a computer-readable storage medium or to an external computer or external storage device via a network.

Computer-readable program instructions stored in a computer-readable medium may be used to direct a computer, other types of programmable data processing apparatuses, or other devices to function in a particular manner, such that the instructions stored in the computer-readable medium produce an article of manufacture including instructions that implement the functions, acts, and/or operations specified in the flow-charts, sequence diagrams, and/or block diagrams. The computer program instructions may be provided to one or more processors of a general purpose computer, a special purpose computer, or other programmable data processing apparatus to produce a machine, such that the instructions, which execute via the one or more processors, cause a series of computations to be performed to implement the functions, acts, and/or operations specified in the flow-charts, sequence diagrams, and/or block diagrams.

In certain alternative embodiments, the functions, acts, and/or operations specified in the flow-charts, sequence diagrams, and/or block diagrams may be re-ordered, processed serially, and/or processed concurrently consistent with embodiments of the invention. Moreover, any of the flow-charts, sequence diagrams, and/or block diagrams may include more or fewer blocks than those illustrated consistent with embodiments of the invention.

The terminology used herein is for the purpose of describing particular embodiments only and is not intended to be limiting of the embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, actions, steps, operations, elements, and/or components, but do not preclude the presence or addition of one or more other features, integers, actions, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising”.

While all of the invention has been illustrated by a description of various embodiments and while these embodiments have been described in considerable detail, it is not the intention of the Applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the Applicant's general inventive concept.

What is claimed is:

1. A database management system for processing an exchange of an issued ticket for a reissue ticket, the system comprising:
one or more processors; and
a memory coupled to the one or more processors, the memory storing first data comprising a first database and instructions that, when executed by the one or more processors, cause the system to:
receive a request to reprice a reservation record from a user system;
determine a context of the exchange;
query the first database for a penalty collection process that matches the context of the exchange;
determine a penalty for exchanging the issued ticket for the reissue ticket in accordance with the penalty collection process returned by the first database;
generate a price for the reissue ticket based at least in part on the penalty; and
transmit, to the user system, a reply that includes the price for the reissue ticket.

2. The system of claim 1 wherein the instructions further cause the system to:
attach a dedicated message to the reply that identifies the penalty collection process.

3. The system of claim 2 wherein the instructions further cause the system to:
display, on the user system based on the dedicated message attached to the reply, data indicative of the penalty collection process.

4. The system of claim 3 wherein the data indicative of the penalty collection process indicates whether the penalty is included in the reissue ticket, the penalty is included in the reissue ticket and the reservation record needs an update, or the penalty is not included in the reissue ticket.

5. The system of claim 2 wherein the instructions further cause the system to:
create a persistent element in the reservation record; and
store at least a portion of the dedicated message in the persistent element.

6. The system of claim 1 wherein the instructions further cause the system to:
generate a transitional ticket corresponding to an itinerary defined by the reservation record;
add a tax element or a surcharge element to the transitional ticket; and
store the penalty in the tax element or the surcharge element,
wherein the penalty collection process defines how the penalty is added to the transitional ticket.

7. The system of claim 1 wherein the instructions further cause the system to:
generate a transitional ticket corresponding to an itinerary defined by the reservation record;
add the penalty to a total amount for the transitional ticket; and
store the total amount in a total amount element of the transitional ticket,
wherein the penalty collection process defines how the penalty is added to the transitional ticket.

8. The system of claim 1 wherein the context of the exchange includes data defining an element selected from the group consisting of a market in which the reissue ticket is being sold, and a validating carrier for a segment of the reissue ticket.

9. The system of claim 8 wherein the request includes a record locator that identifies the reservation record, and the instructions cause the system to determine the context of the exchange by:
retrieving the reservation record identified by the record locator from a second database of reservation records; and
identifying, based on the reservation record, the validating carrier, the market in which the reissue ticket was sold, or both the validating carrier and the market.

10. A method of processing an exchange of an issued ticket for a reissue ticket, the method comprising:
receiving, at a database management system from a user system, a request to reprice a reservation record;
determining, by the database management system, a context of the exchange;
querying, by the database management system, a first database for a penalty collection process that matches the context of the exchange;
determining, by the database management system, a penalty for exchanging the issued ticket for the reissue ticket in accordance with the penalty collection process returned by the first database;
generating, by the database management system, a price for the reissue ticket based at least in part on the penalty; and
transmitting, by the database management system to the user system, a reply that includes the price for the reissue ticket.

11. The method of claim 10 further comprising:
attaching a dedicated message to the reply that identifies the penalty collection process.

12. The method of claim 11 further comprising:
displaying, on the user system based on the dedicated message attached to the reply, data indicative of the penalty collection process.

13. The method of claim 12 wherein the data indicative of the penalty collection process indicates whether the penalty is included in the reissue ticket, the penalty is included in the reissue ticket and the reservation record needs an update, or the penalty is not included in the reissue ticket.

14. The method of claim 13 wherein if the penalty is not included in the reissue ticket, the data indicative of the penalty collection process further indicates how to account for the penalty.

15. The method of claim 11 further comprising:
creating a persistent element in the reservation record; and
storing at least a portion of the dedicated message in the persistent element.

16. The method of claim 10 further comprising:
generating a transitional ticket corresponding to an itinerary defined by the reservation record;
adding a tax element or a surcharge element to the transitional ticket; and
storing the penalty in the tax element or the surcharge element,
wherein the penalty collection process defines how the penalty is added to the transitional ticket.

17. The method of claim 10 further comprising:
generating a transitional ticket corresponding to an itinerary defined by the reservation record;
adding the penalty to a total amount for the transitional ticket; and
storing the total amount in a total amount element of the transitional ticket,
wherein the penalty collection process defines how the penalty is added to the transitional ticket.

18. The method of claim 10 wherein the context of the exchange includes data defining an element selected from the group consisting of a market in which the reissue ticket is being sold, and a validating carrier for a segment of the reissue ticket.

19. The method of claim 18 wherein the request includes a record locator that identifies the reservation record, and determining the context of the exchange comprises:
retrieving the reservation record identified by the record locator from a second database of reservation records; and
identifying, based on the reservation record, the validating carrier, the market in which the reissue ticket was sold, or both the validating carrier and the market.

20. A computer program product for processing an exchange of an issued ticket for a reissue ticket, the computer program product comprising:
a non-transitory computer-readable storage medium; and
program code stored on the non-transitory computer-readable storage medium that, when executed by one or more processors, causes the processors to:
receive a request to reprice a reservation record from a user system;
determine a context of the exchange;
query a database for a penalty collection process that matches the context of the exchange;
determine a penalty for exchanging the issued ticket for the reissue ticket in accordance with the penalty collection process returned by the database;
generate a price for the reissue ticket based at least in part on the penalty; and
transmit, to the user system, a reply that includes the price for the reissue ticket.
